(19) United States
(12) Patent Application Publication
(10) Pub. No.: US 2007/0033873 A1
(43) Pub. Date: Feb. 15, 2007

(54) Hydrogen gas generator

(76) Inventor: Melanius D'Souza, San Dimas, CA (US)

Correspondence Address: MELANIUS D'SOUZA, 1718 AVENIDA ENTRADA, SAN DIMAS, CA, 91773-4314, US

(21) Appl. No.: 10/378,730

(22) Filed: Mar. 3, 2003

Related U.S. Application Data
(60) Provisional application No. 60/360,947, filed on Mar. 2, 2002.

(51) Int. Cl. B01J 8/00

(52) U.S. Cl. 48/198.7; 48/127.9

(57) ABSTRACT

An apparatus and method for generating a hydrogen containing product gas from a reactant stream comprising at least one reactant chosen from the set of reactants consisting of water, oxygen, carbon-monoxide, and a hydrocarbon fuel. The apparatus includes a heat storage bed in fluid communication with a reactor. The heat storage bed contains regenerative heat sink media. Hot flue gas produced from the oxidation of fuel and/or low-BTU gas, heats the heat sink media in the heating mode of operation of the apparatus. In a subsequent reforming mode of operation of the apparatus, the cold reactant stream is heated by the hot heat sink media. The heated reactant stream is then passed through suitable catalysts in the reactor to produce a hydrogen containing product gas. The heating and reforming modes of operation of the apparatus are repeated as long as required for the production of the hydrogen containing product gas.

### CROSS REFERENCE TO RELATED APPLICATIONS

This application claims the benefit of U.S. Provisional application No. 60/360,947 filed on Mar. 2, 2002.

### FIELD OF THE INVENTION

This invention relates to fuel-reforming systems for the generation of a hydrogen-containing product gas for use in fuel-cells and other hydrogen gas consuming applications.

### BACKGROUND OF THE INVENTION

There is currently a major focus worldwide for developing fuel-cells for generating electricity in a clean and efficient manner. However, as is widely known, fuel-cells use hydrogen as a source of fuel to produce electricity while generating clean water only as a waste product. One of the major problems confronting the widespread use of fuel-cells in the U.S.A. is the lack of an hydrogen infrastructure.

In the current state of the art, hydrogen is generally produced from natural gas in an apparatus called a fuel-reformer. A mixture of natural gas, steam, and air is passed into the fuel-reformer wherein a series of well-known reactions take place to create hydrogen-containing product gas stream. One of the most commonly used reactions is the endothermic Steam-Methane Reforming (SMR) reaction. The other commonly used reaction is the exothermic Water Gas Shift (WGS). The need to balance the requirement of heat for the endothermic SMR reaction and to dissipate the excess heat generated by the exothermic WGS reaction is a major problem in the design and operation of fuel-reformers.

Generally, the design of fuel-reformers attempts to transfer the heat generated in the exothermic WGS reaction to the endothermic SMR reaction. However, this is a very difficult objective to achieve in practice because of the different rates at which heat is generated in the WGS reaction and the rate at which heat is required to sustain the endothermic SMR reaction. Fuel-reformers generally are designed with a number of very complicated heat transfer loops to try to achieve the above objective. An example of such complicated heat transfer loops is shown in FIGS. 2, 3, and 13 of US patent application 2002/0071790 by Woods et al. These heat transfer loops add substantially to the complex task of designing and operating the fuel-reformer. Also, these heat transfer loops generally use recuperative heat exchangers which are limited in their efficiency because of thermodynamically imposed constraints. Further, these heat exchangers have to be fabricated of very exotic materials of construction to withstand the high temperatures (in the range of 1,000 to 1,800 degrees Fahrenheit.) within the reaction zones of the fuel-reformer. All of these factors add greatly to the cost and design complexity of fuel-reformers.

Another approach that is used in the art is to use an Advanced Catalyst. As described in the above referenced patent application by Woods et al., the Advanced Catalyst oxidizes a small portion of the hydrocarbon fuel in a Catalytic Partial Oxidation (CPO) reaction to produce the heat required for the endothermic SMR reaction. This approach however has the disadvantage that a portion of the hydrocarbon fuel is consumed as a source of heat rather than a source of hydrogen, thereby reducing the hydrogen generating capacity of the fuel reformer. The CPO reaction also produces carbon monoxide, which can poison the catalyst and the fuel cell. Therefore a “polishing” step is required to reduce the concentration of carbon monoxide in the hydrogen containing product gas to meet consumer or fuel-cell specifications. This polishing step further adds to the cost and complexity of the fuel-reformer.

There is therefore a great need for a simple fuel-reformer to economically generate hydrogen. Such a fuel-reformer has to be simple in construction, have no complicated heat transfer loops, use inexpensive means of heat transfer, use low-BTU waste gas as a means for generating heat for the SMR reaction, and have a high efficiency of hydrogen production.

### SUMMARY OF THE INVENTION

In one aspect of the invention, a fuel-reformer comprises a heat storage bed containing heat sink media and a reactor containing at least one catalyst which is suitable for generating a hydrogen-containing product gas from a reactant stream which comprises at least one reactant chosen from the set of reactants consisting of water, carbon-monoxide, oxygen, and a hydrocarbon fuel. An interconnecting duct provides fluid communication between the heat storage bed and the reactor. The reactor can comprise of one or mote catalyst layers separated by interstage heat storage media beds. The top section of the housing containing the heat storage bed is configured as a combustion chamber which includes a burner or a combustion catalyst for combusting a hydrocarbon fuel.

In another aspect of the invention, a method of generating hydrogen containing product gas comprises operating the fuel reformer alternately in a heating mode and a reforming mode. In the heating mode of operation, the hydrocarbon fuel is combusted in the burner to produce hot products of combustion. Cold air or steam is also passed through the reactor which was previously heated in a previous reforming mode to desorb heat from the catalyst and interstage heat storage beds in the reactor. The heated air or steam is then passed into the heat-storage bed wherein the heat from the heated air or steam is transferred to the heat sink media within the heat storage bed. To reduce the fuel consumption in the burner, low BTU gas such as Anode Off Gas (AOG) or sour-gas or sewer gas or solvent laden air can be added to the heated air. The combustibles in the low BTU gas oxidize within the burner chamber to produce additional heat, which is also stored in the heat sink media of the heat storage bed.

In the reforming mode of operation, the burner is shut off and the flow of air or steam through the reactor and the heat storage bed is stopped. The reactant stream is then flowed through the heat storage bed. The colder reactant stream absorbs heat from the heat sink media in the heat storage bed and is heated while the heat sink media is gradually cooled. The heated reactant stream is then passed through the catalyst to produce a hydrogen-containing product gas. After a period of time, when the heat sink media has cooled to a point where it cannot adequately heat the reactant stream, the flow of the reactant stream is stopped and the fuel-reformer is again operated in the heated mode as previously described.

In a first embodiment of the invention, the catalyst is a SMR catalyst and the reactant stream comprises water and hydrocarbon fuel. The SMR catalyst produces an hydrogen containing product gas, which can be further enriched by adding additional water and passing through a WGS catalyst. The temperature of the hydrogen containing product gas is maintained at the required levels for operation of the different catalysts by passing the hot hydrogen containing gas through the heat sink media inter-stages in the reactor.

The invention can also be practiced using an Advanced Catalyst which uses a mixture of water, air, and hydrocarbon fuel as the reactant stream. The Advanced Catalyst is capable of facilitating both the Catalytic Partial Oxidation (CPO) reaction as well as the SMR reaction. Thus, the Advanced Catalyst partially oxidizes some of the hydrocarbon fuel to provide heat for the endothermic SMR reaction.

The invention can also be practiced with a WGS catalyst alone using carbon-monoxide and steam as the reactants. This configuration of the fuel-reformer can be used where there is a source of carbon-monoxide and steam for use as the reactants in the WGS reaction.

Instead of using a burner to provide the heat, a combustion catalyst can also be used to oxidize the combustibles in the low-BTU gas. The combustion catalyst can be heated to its operating temperature using an electrical heating element. This arrangement can be used to conserve hydrocarbon fuel.

These and other features, aspects, and advantages of the present invention will become better understood with reference to the following drawings, descriptions, and claims.

### BRIEF DESCRIPTION OF THE DRAWINGS

FIG. 1 shows a schematic flow-representation of a first embodiment of a fuel reformer system according to the present invention for generating a hydrogen-containing gas stream from a fossil fuel such as methane, propane, kerosene, diesel, naphtha, etc.

FIG. 2 is a second embodiment of a fuel-reformer system according to the present invention.

FIG. 3 is a third embodiment of a fuel-reformer system according to the present invention.

FIG. 4 is a fourth embodiment of a fuel-reformer system according to the present invention.

FIG. 5 is a fifth embodiment of a fuel-reformer system according to the present invention.

FIG. 6 is a sixth embodiment of a fuel-reformer system according to the present invention.

FIGS. 7A, and 7B show design variations of a seventh embodiment of a fuel-reformer system according to the present invention.

FIGS. 8A, and 8B represent the heating and reforming modes of operation of the fuel-reformer system according to the present invention for continuous production of the hydrogen containing product gas.

### DESCRIPTION OF THE INVENTION

As defined herein, a Steam Methane Reforming (SMR) catalyst is any catalyst that can facilitate the SMR reaction. As an example, a SMR reaction using methane as the hydrocarbon fuel is shown below. However, any other hydrocarbon fuel could also be used to produce hydrogen according to the general principle of the following reaction.
CH₄+H₂0+heat→CO+3H₂
As shown above, this reaction is highly endothermic and may take place without a catalyst at a high operating temperature. However, a SMR catalyst is typically used to enable the reaction to take place at a lower temperature. The SMR reaction provides a high quality of hydrogen but requires heat input for its sustenance. In conventional fuel reformers, this heat is provided by partially oxidizing some of the hydrocarbon in a Catalytic Partial Oxidation (CPO) as described by the following equation for the partial oxidation of Methane. This result is achieved by using an Advanced Catalyst which can facilitate both the SMR reaction, shown above, and the CPO reaction, shown below.
CH₄+0.5(O₂)→CO+2(H₂)+heat
As shown above, the CPO reaction is exothermic and is capable of generating large amounts of heat rapidly to meet the heat demand of the SMR reaction. Therefore, the use of the Advanced Catalyst improves the response of the fuel-reformer to meet the hydrogen demands of the customer or the fuel cell. The disadvantage of using the Advanced Catalyst is that a portion of the fuel is consumed in the CPO reaction to produce heat to sustain the endothermic SMR reaction. This consumption of fuel for heat-production reduces the overall fuel-conversion efficiency of the fuel-reformer. Further, the partial oxidation of the fuel also produces Carbon-Monoxide which can poison the catalysts and the fuel-cell. The removal of this Carbon-Monoxide to safe levels requires post processing of the hydrogen-containing product gas using a suitable “polishing” method such as a Preferential Oxidation (PROX) Catalyst. In the PROX catalyst, the carbon-monoxide is preferentially oxidized to carbon-dioxide. However, some of the hydrogen is also oxidized, thereby reducing the overall hydrogen generation efficiency of the fuel-reformer. Thus the use of an Advanced Catalyst produces lower quality hydrogen containing product gas than can be achieved by the use of a SMR catalyst alone. Further, the Advanced Catalyst is relatively more expensive than the SMR catalyst. Yet further, the generation of carbon-monoxide by an advanced catalyst requires the use of a PROX catalyst for final polishing of the hydrogen-containing product gas to acceptable customer or fuel-cell specifications.

As is commonly practiced in the art, the concentration of hydrogen in the hydrogen containing product gas produced by the SMR reaction is further improved by passing the products of reaction of the SMR catalyst into a Water Gas Shift (WGS) Reaction Catalyst. The WGS reaction is as follows:
CO+H₂O→CO₂+H₂+heat
As is well known and practiced, the WGS reaction is generally carried out in two stages. The first stage occurs at a high temperature and is generally known as the High Temperature Shift (HTS) Reaction. The catalyst used for for this stage is generally known as the HTS catalyst. The second stage occurs at a lower temperature and is generally known as the Low Temperature Shift (LTS) Reaction. The catalyst used for for this stage is generally known as the LTS catalyst. Both of these reactions are exothermic. In conventional fuel-reformers, the heat generated by the HTS and LTS reactions is transferred to the SMR reaction region by means of one or more heat transfer loops as described in previously referenced patent application to Woods et. al. These heat transfer loops add greatly to the complexity of the fuel-reformer.

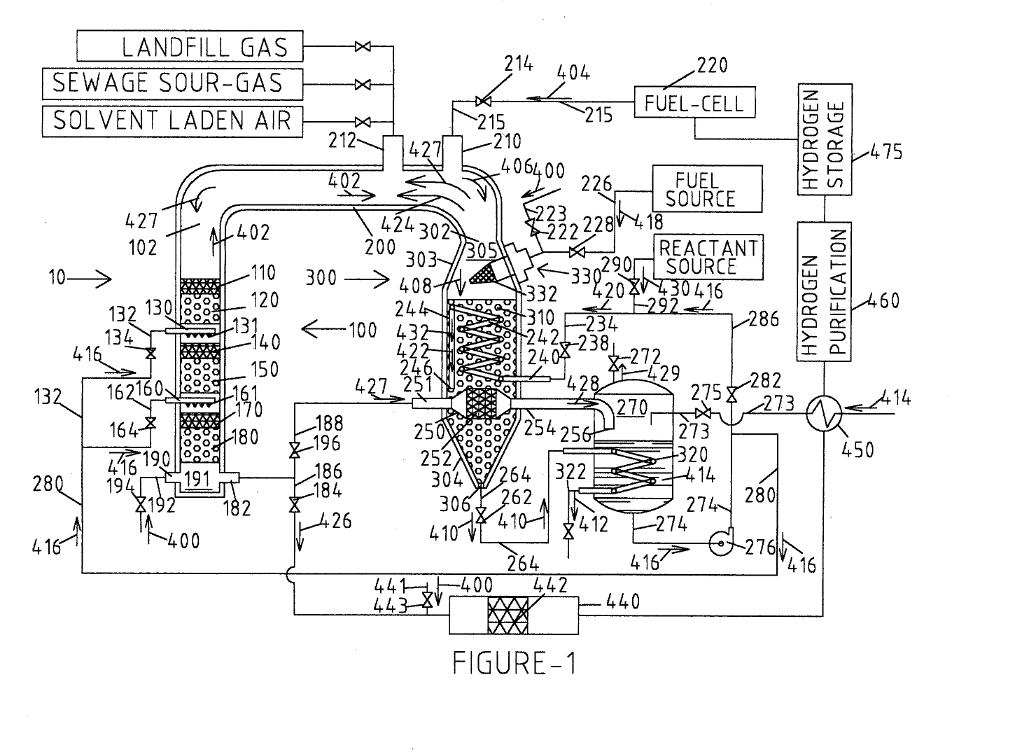

Referring now to FIG. 1, the fuel-reformer 10 of the present invention comprises a first catalytic reactor vessel 100 and a heat storage vessel 300, which are interconnected by a duct 200.

As shown in FIG. 1, reactor vessel 100 has an opening 102 at its top end and is closed at its bottom end. Reactor vessel 100 is made of a suitable material such as steel and is insulated, either internally or externally to conserve energy. Located from top to bottom in reactor vessel 100 are Steam-Methane Reforming (SMR) Catalyst 110, first heat sink media bed 120, High Temperature Shift (HTS) catalyst 140, second heat sink media bed 150, Low Temperature Shift (LTS) catalyst 170, and third heat sink media bed 180. First HSM bed 120, second HSM bed 150, and third HSM bed 180 constitute the interstage HSM beds in reactor 100. The catalysts and the interstage heat sink media beds are supported on suitable supports (not shown) which are well known in the art. The design of the supports for heat sink media beds and catalyst is well known. Such supports could include metal or ceramic grids or metal wire mesh or bar grating as well as other methods of supporting beds of random or structured packing.

The SMR, HTS, and LTS catalysts that are used in reactor vessel 100 are well known in the art and are readily available from US catalyst manufacturers such as Engelhard Corporation, Johnson-Mathey Inc., Prototech Inc., and others.

As described previously, an Advanced Catalyst which facilitates both the SMR and the CPO reactions could also be used as SMR catalyst 110 in fuel-reformer 10 of the present invention instead of a catalyst which facilitates only the SMR reaction. This substitution could be justified because the Advanced Catalyst is able to respond more quickly to changes in demand for hydrogen than a SMR catalyst alone. Thus, in situations, where a rapid response is necessary, the Advanced Catalyst can be therefore be used instead of the SMR catalyst as described above in the present invention.

The media used in heat sink media beds 120, 150, and 180 is also well known in the art and is readily available from US manufacturers such as Norton Process Co., Lantec Products Inc., Koch Inc., and others. For example, ceramic saddles or balls or monolith media that is commonly used in regenerative thermal oxidizers and regenerative heat-exchangers could be used as the heat sink media. Alternatively, naturally occurring materials such as rocks or gravel could also be used as the heat sink media depending on the durability and the temperature handling capability of such materials. Or the manufactured media and naturally occurring materials described above could be used in combination. Yet further, metallic heat sink media such as metal balls or bars or ribbons or plates and other such configurations which are well known in the regenerative heat exchanger art can also be used.

As can be seen in FIG. 1, a first distributor 130 is located in between first heat sink media bed 120 and HTS catalyst 140. As will be described later, distributor 130 is used to add additional steam to the products of reaction from the SMR catalyst to try to force the WGS reaction towards completion. Distributor 130 is connected to a line 132, which is connected to a source of hot water 416. Distributor 130 has atomizers 131, which are used to inject fine sprays of hot water 416 into the space between heat sink media bed 120 and HTS catalyst 140. Atomizer 131 could be spray nozzles or orifices in distributor 130 or any other means of injecting liquid into a gas stream. It is obvious that distributor 130 could also be located within heat sink media bed 120 without affecting its function as a distributor.

Also, as can be seen in FIG. 1, a second distributor 160 is located in between second heat sink media bed 150 and LTS catalyst 170. Distributor 160 is also connected to a line 162, which is also connected to the source of hot water 416. Distributor 160 also has atomizers 161, which are used to inject fine sprays of hot water 416 into the space between heat sink media bed 150 and LTS catalyst 170. As will be described later, distributor 160 is used to add additional steam to the products of reaction from HTS catalyst 140 to drive the WGS reaction further towards completion.

As previously described, the lower portion of reactor vessel 100 is closed under heat sink media bed 180 to form closed volume 191. Connected to closed volume 191 is a first connection 190, which is connected to a source of air 400 by line 192. Located in line 192 is a control valve 194, which is used to regulate the quantity of air 400 that is flowed into reactor vessel 100. Also attached to closed volume 191 is a second connection 182, which is used to convey the hydrogen-containing product gas 426 generated by fuel-reformer 10 to a subsequent stage such as a carbon-monoxide polishing unit or a hydrogen purification system or a hydrogen storage system or a fuel cell.

Heat storage vessel 300 has a top opening 302, which is connected to reactor vessel 100 by interconnecting duct 200. Interconnecting duct 200 and heat storage vessel 300 are also insulated, either internally or externally, to conserve heat. A connection 210 is provided in interconnecting duct 200 to introduce Anode Off Gas (AOG) 404 from fuel-cell 220 to the anode off-gas oxidizer (AGO) 305 (which is described below), located within heat storage vessel 300. As shown in FIG. 1, additional optional connections such as 212, which are similar to 210, can also be provided in interconnecting duct 200 to introduce other low BTU gas streams into interconnecting duct 200. Examples of low BTU gas streams could include sour-gas streams from sewage plants or landfill gas from landfills or methane from animal waste treatment centers in farms or VOC containing air (or Solvent Laden Air (SLA)) from industrial/commercial processes.

As shown in FIG. 1, heat storage vessel 300 is configured as a vessel with a conical or pyramidal top 303 and an inverted conical or pyramidal bottom 304. An opening 302 is provided in top 303 for fluid communication of interconnecting duct 200 to heat storage vessel 300. An outlet 306 is provided in bottom 304 for removal of cooled AGO exhaust gas and combustion flue gases from heat storage vessel 300 as will be described further below.

Heat storage vessel 300 is filled with a heat sink media 310 which is similar to that described above with respect to HSM beds 120, 150, and 180. Located within heat sink media 310 is a heat-transfer coil 242 whose inlet end is connected to connection 240 which extends through the wall of reactor vessel 300. As will be described further below, heat transfer coil 242 is used to generate steam from hot water 416 that is flowed through its connection 240. The top end of heat transfer coil 242 is connected to an outlet tube 244, which has an open end 246. The open end 246 is located to direct the flow of steam 422 that is generated in coil 242 towards the bottom end 304 of reactor vessel 300.

Also located within heat sink media 310 is a catalytic combustion reactor 250, which contains suitable combustion catalyst 252 for oxidizing combustibles such as hydrogen, carbon-monoxide, and hydrocarbons. The location of catalytic combustion reactor 250 within heat-sink media 310 is selected so that combustion catalyst 252 is maintained at a temperature that is suitable for the catalyst to initiate and sustain the oxidation of the combustibles. An inlet connection 251 supplies the combustibles to the combustion catalyst 252. Inlet connection 251 is connected to outlet connection 182 of reactor vessel 100 by line 188. A control valve 196 is provided in line 188 to regulate the flow of the combustibles-containing gas through line 188 to catalytic combustion reactor 250. An outlet connection 254 conveys the oxidized gases from catalytic reactor 250 to hot water storage tank 270, which will be described below.

Attached to outlet 306 in lower conical section 304 is a line 264 which conveys the cooled exhaust gas 410 out of storage vessel 300. The cooled exhaust gas may be either exhausted to atmosphere (not shown) or to a heat transfer coil 320, which is located within hot water storage tank 270, for further heat recovery before being exhausted to the atmosphere in a cooled state. Alternately, the cooled exhaust gas 410 may transfer its heat by direct contact with the relatively colder water 141 in hot water storage vessel 270.

Top section 303 of reactor vessel 300 functions as a combustion chamber 305 for the oxidation of Anode Off Gas (AOG) or other such low-BTU gas. Located in combustion chamber 305 is a burner 330. A mixture of fuel 418 and air 400 is premixed and fed to burner 330 wherein combustion takes place on a combustion matrix 332. The combustion of fuel 418 provides heat energy, which is used to raise the temperature of heat sink media 310 in heat storage vessel 300 as will be described further below. It will be obvious that other types of burners, such as pre-mixed burners or raw-gas burners could also be used as burner 330 instead of the matrix burner described above. The matrix-equipped burner 330 of FIG. 1 could also combust the AOG 404 instead of the fuel-air mixture as described above.

Water 414 for use in the SMR and WGS reactions within reactor vessel 100 is stored in water storage tank 270. The water 414 is introduced into water storage tank 270 through control valve 275 through water inlet line 273. The water level in tank 270 is maintained by a liquid level control system (not shown) such as a float-valve or other such well-known means of controlling liquid level within a tank. Connecting pipe 254 from catalytic combustion reactor 250 conveys hot oxidized gases 428 from reactor 250 to hot water tank 270. Hot gases 428 are arranged for direct heat transfer with water 414 so that the waste heat of hot gases 428 is transferred to the relatively colder water 414 to conserve energy. A direct contact type scrubber arrangement or liquid gas contacting means such as bubble trays or other means of intimately contacting the hot gas with the relatively colder water may be used to improve the heat transfer efficiency. Alternately, connecting pipe 254 can be submerged in water 414 to improve the heat transfer efficiency. The non-condensable cooled gases in hot gases 428 are exhausted from hot water tank 270 through vent valve 272 which is located at the top of hot water tank 270.

As described above, a coil 320 is immersed in water 414 within water tank 270. Coil 320 is connected to outlet opening 306 of heat storage vessel 300 through line 264. The flow of gases 410 from opening 306 to coil 320 is regulated by means of control valve 262 which is located in line 264. The cooled exhaust gases 412 are removed from coil 320 by outlet pipe 322, which is connected to the outlet end of coil 320.

The following paragraphs describe the operation of fuel-reformer 10. Fuel reformer 10 is operated in two modes. The first mode is the heat storage mode and the second mode is the reforming mode. The two modes of operation are repeated as long as required for the generation of hydrogen containing product gas 426. During the heat storage mode, air 400 is introduced into reactor vessel 100 through control valve 194 in line 192 to connection 190 in space 191 of reactor vessel 100. Instead of air 400, steam or an inert gas such as nitrogen could also be used for the purpose of removing heat from previously heated heat sink beds 180, 150, and 120. In reactor vessel 100, air 400 flows upwards through heat sink media 180, LTS catalyst 170, heat sink media 150, HTS catalyst 140, heat sink media 120, and SMR catalyst 110. During initial startup, these components are cold. Therefore, when fuel-reformer 10 is first started up, air 400 will pass without heating through the cold components of reactor 100 and will exit SMR catalyst 110 at approximately the same temperature as it entered heat-sink media 180.

However, at a later stage of operation of fuel-reformer 10, the components will have been heated up during a previous reforming mode of operation as will be described below. Therefore, during later stages of operation, the relatively colder air 400 will receive heat from the previously heated components and will get heated. The heated air is shown in FIG. 1 by the reference numeral 402.

Heated air 402 leaves reactor vessel 100 through opening 102 and enters interconnecting duct 200. In interconnecting duct 200, the heated air 402 is optionally mixed with anode off gas 404 which is emitted from fuel-cell 220 and which is introduced into interconnecting duct 200 through connection 210. The anode off-gas 404 is conveyed from fuel-cell 220 to connection 210 through line 215. The flowrate of anode off-gas 404 is regulated by control valve 214 in line 215. As shown in FIG. 1, other low BTU-gases such as landfill gas, sewage sour gas, and solvent laden air from industrial processes can also be introduced into interconnecting duct 200 through an optional second connection 212.

The mixture of heated air 402 and anode off-gas 404 and/or low BTU gas is shown as 406 in FIG. 1. Mixture 406 enters heat storage vessel 300 through opening 302 into combustion chamber 305 wherein it flows past burner 330.

In burner 330, a mixture of fuel 418 and air 400 is premixed and combusted on combustion matrix 332. The hot flue gases resulting from the combustion of fuel 418 are mixed with gas mixture 406 from interconnecting duct 200. The temperature of gas mixture 406 is raised above the auto-ignition temperature of the combustibles in gas mixture 406. Therefore the combustibles in gas mixture 406 are oxidized. The oxidation produces heat which further raises the temperature of the gas to a range of between 1,200 to 2,000 degrees Fahrenheit. The resulting hot gas mixture is shown as 408 in FIG. 1. Hot gas mixture 408 is then flowed through the relatively colder heat storage media 310 in heat storage vessel 300. Heat is transferred from the hot gas mixture 408 to the relatively colder heat storage media 310. Hot gas mixture 408 then exits heat storage vessel 300 through outlet 306 as cooled gas 410. Cooled gas 410 is then flowed through connecting line 264 to heating coil 320 in hot water storage tank 270 wherein it gives up additional heat to the relatively cold water 414 in the hot water storage tank 270. As previously described, the cooled gas 412 is removed from heating coil 320 by outlet connection 322.

As hot gas mixture 408 flows downwards through heat storage media 310, a hot zone is created within the heat storage media 310. The temperature of the hot zone varies between 1,200 to 2,000 degrees Fahrenheit. As the hot gas mixture 408 continues to flow downwards through heat storage media 310, the depth of the hot zone increases until the hot zone comprises a large proportion of heat storage media 310. At this point, the temperature of the cooled gas 410 starts to rise rapidly. When the temperature of the cooled gas 410 has risen to a pre-determined level in the range of 100 to 300 degrees Fahrenheit, the flow of fuel 418 and air 400 into burner 330 is stopped by closing valves 228 and 222 respectively. Further, control valve 214 for the flow of anode off-gas into interconnecting duct 200 is also closed. The flow of any other low BTU gases such as sewage-plant sour gas or landfill gas or VOC containing gaseous effluent or SLA into the interconnecting duct 200 is also stopped by closing the appropriate control valves. Control valve 192 is also closed to stop the flow of air 400 through reactor vessel 100. This concludes the heat storage mode of operation of the reformer.

The reforming mode of operation follows the heat storage mode of operation described above. During the reforming mode of operation, valve 196 in line 188 to catalytic combustion reactor 250 is opened and valve 184 in line 186 to the carbon-monoxide polishing stage or hydrogen purification system or hydrogen storage system or fuel cell is closed.

Hot water 416 is then conveyed from hot water storage tank 270 to steam generation coil 242 in heat storage vessel 300 by hot water pump 276 and hot water lines 274, 286, and 234 to connection 240. The flow of hot water 416 is controlled by control valves 282 and 238. As the hot water 416 flows through steam generation coil 242, it absorbs some of the stored heat in heat storage media 310 and is converted to steam 422 which flows out of opening 246 in coil outlet connection 244.

As stated previously, opening 246 is located so that steam 422 can efficiently sweep away any of the residual gases that were previously generated in the heat storage mode of operation and now remain in heat storage vessel 300. Thus any combustibles and oxygen that are remaining in heat storage vessel 300 are swept away by steam 422. The mixture of steam 422 and residual gases, shown by reference numeral 427 in FIG. 1, then flow upwards through the heat storage vessel 300. Steam-residual gas (SRG) mixture 427 flows out of heat storage vessel 300 through opening 302 into interconnecting duct 200. Steam-residual gas mixture 427 then flows through interconnecting duct 200 into reactor vessel 100 through opening 102. SRG mixture 427 then flows downwards through SMR, HTS and LTS catalysts 110, 140, 170 and heat sink media beds 120, 150, and 180 and then exits reactor vessel 100 through outlet connection 182. Finally, SRG mixture 427 flows from connection 182 into catalytic combustion reactor 250 through connecting line 188 and control valve 196.

In catalytic combustion reactor 250, the combustibles within SRG mixture 427 are oxidized when contacted with the combustion catalyst 252 to generate hot oxidized gas 428. Hot oxidized gas 428 is then removed from the catalytic combustion reactor 250 and is conveyed to hot water tank 270 by connecting pipe 254. Hot oxidized gas 428 then exits through outlet opening 256 of connecting pipe 254. As described previously, the outlet opening 256 is arranged so hot oxidized gas 428 can contact and heat water 414 in hot water tank 270. Connecting pipe 254 could be partially submerged in water 414 so that heat can be more efficiently transferred from hot gas 428 to water 414. Opening 256 can also be submerged so hot gas 428 can bubble through water 414 to provide more efficient heat transfer. Such refinements of the design of the gas-water heat transfer system will be obvious to one having skill in the art. The uncondensed cooled gas 429 exits vessel 270 through vent 272.

After a sufficient period of time for sweeping all combustible gases and oxygen out of heat storage vessel. 300, interconnecting duct 200, and reactor vessel 100, valve 290 is opened in connecting line 292 from a reactant source to introduce reactant 430 into water line 286. Reactant 430 can be any hydrocarbon such as methane or propane, which can be used as a reactant in the Steam Methane Reforming (SMR) reaction. Depending on the capabilities of the SMR catalyst, other hydrocarbons such as kerosene, diesel, methanol, naphtha, etc. could also be used as reactant 430 in the SMR reaction. The mixture of reactant 430 and water 416 is shown by the reference numeral 420. Reactant-water mixture 420 flows through line 234 and through control valve 238 into steam generation coil 242. Valves 290 and 282 are used to control the flow rates of reactant 430 and water 416 at the proportions required for the SMR reaction.

As reactant-water mixture 420 flows through steam generation coil 242, water 416 in reactant-water mixture 420 evaporates to form steam. Thus a reactant and steam mixture 432 is generated within the steam generation coil 242. Reactant-steam mixture 432 exits coil 242 through opening 246 of outlet 244 of coil 242 and passes upwards through the heat sink media 310 in heat storage vessel 300. As reactant-steam mixture 432 moves through heat-sink media 310, it absorbs heat from the previously heated heat-sink media 310. The reactant-steam mixture 432 is heated to a suitable temperature, between 1,000 to 1,800 degrees Fahrenheit. for the SMR reaction to take place when the heated reactant-steam mixture 432 contacts SMR catalyst 110. Since the SMR reaction is endothermic, the SMR reaction is facilitated by the high temperature of reaction-steam mixture 432.

The heated reactant-steam mixture, shown as 424 in FIG. 1, then passes through opening 302 of heat-storage vessel 300 into interconnecting duct 200 and then into reactor vessel 100. In reactor vessel 100, the heated reactant-steam mixture 424 first contacts SMR catalyst 110 wherein the reactant and the water in the mixture combine according to the SMR reaction, shown above, to form a mixture of hydrogen and carbon-monoxide. As is common practice in the art, excess steam is used to try to force the SMR reaction to completion. Therefore the products of reaction from SMR catalyst 110 also contain some excess steam.

Since the SMR reaction is an endothermic reaction, the SMR reaction products are cooler than the reactant-steam mixture 424. The SMR reaction products are then passed through first heat sink media bed 120 wherein they lose more of their heat by heat exchange with the relatively colder heat sink media in heat sink media bed 120. Thus the heat sink media bed 120 is heated while the SMR reaction products are partially cooled. Additional water 416 is then sprayed through atomizers 131 of distributor 130 into the hot SMR reaction products after they exit heat sink media bed 120. The additional water 416 evaporates in the hot SMR reaction products to provide more steam. The evaporation of water 416 further reduces the temperature of the SMR reaction products to a suitable temperature in the range of 500 to 800 degrees Fahrenheit which is required for the subsequent HTS reaction. Thus the proportion of steam in the reactant gas mixture is increased to form the reactant mixture for the HTS reaction.

The HTS reactant mixture is then flowed into and contacted with the HTS catalyst 140 wherein the carbon-monoxide and the water react according to the WGS reaction described above. In this reaction, the carbon-monoxide in the HTS reactant mixture is oxidized to carbon-dioxide while the water is reduced to hydrogen. Thus the HTS reaction products contain a higher proportion of hydrogen than was present in the HTS reactant mixture which was introduced into HTS catalyst 140.

Since the HTS reaction is exothermic, heat is evolved and the HTS reaction products exit at a higher temperature than the temperature of HTS reactant mixture which was introduced into HTS catalyst 140. As is well known, to drive the WGS reaction to completion as much as possible, the temperature of the HTS reaction products must be further reduced. This temperature reduction is achieved by passing the HTS reaction products into the second heat sink media bed 150 wherein they are partially cooled by transferring heat to the relatively cooler heat sink media in heat sink media bed 150. The second heat sink media bed 150 is therefore heated while the HTS reaction products are partially cooled.

In a similar manner as described above with respect to distributor 130, additional water 416 is added to the HTS reaction products after they exit heat sink media bed 150. The additional water 416 is added through distributor 160 and atomizers 161. The additional water 416 is converted into steam and increases the proportion of steam in the HTS reaction products to provide the reactant mixture for the LTS reaction. The evaporation of additional 416 into steam reduces the temperature of the reactant mixture for the LTS reactant mixture to about 300 to 500 degrees Fahrenheit. The LTS reactant mixture is then flowed into and contacted with LTS catalyst 170 wherein further reaction occurs between the carbon-monoxide and water to produce additional hydrogen and carbon-dioxide. Generally, a hydrogen-containing product gas 426 containing approximately 30 to 90 percent hydrogen along with carbon-dioxide and a negligible quantity of carbon-monoxide will be produced at this stage of the reforming process.

The hydrogen-containing gas 426 produced by LTS catalyst 170 is further cooled by passing through third heat sink media bed 180. During the initial stage of the reforming mode of operation of reformer 10, the cooled hydrogen-containing product gas 426 is allowed to continue to pass through the catalytic combustion reactor 250 for a short period of time to ensure that all of the residual oxygen in the reformer is removed. The period of time is determined by safety considerations. Valve 184 is then opened to divert the hydrogen containing product gas 426 to the carbon-monoxide polishing unit or the hydrogen purification unit or the hydrogen storage unit or the fuel-cell or other destination. Valve 196 is then closed to shut off the flow of the hydrogen-containing product gas 426 to the catalytic combustion reactor 250.

Before the hydrogen-containing product gas 426 is sent to the fuel-cell or other destination such as a hydrogen purification unit or hydrogen storage unit or hydrogen storage plant or hydrogen end-user plant, it could be subjected to further cleansing of the carbon-monoxide by passing through a carbon-monoxide polishing unit such as Preferential Oxidation (PROX) reactor 440. As is well known in the art, PROX reactor 440 contains PROX catalyst 442, which selectively oxidizes the carbon-monoxide in the hydrogen-containing gas to carbon-dioxide. An example of the PROX catalyst is the Selectoxo™ catalyst from Engelhard Corporation. As shown in FIG. 1, PROX reactor 440 could be located outside the reactor vessel 100 or the heat storage vessel 300. As is commonly the procedure, additional air 400 is added to the hydrogen-containing product gas 426 through line 441 and control valve 443 to provide the oxygen to selectively oxidize the carbon-monoxide in hydrogen-containing product gas 426 in PROX reactor 440.

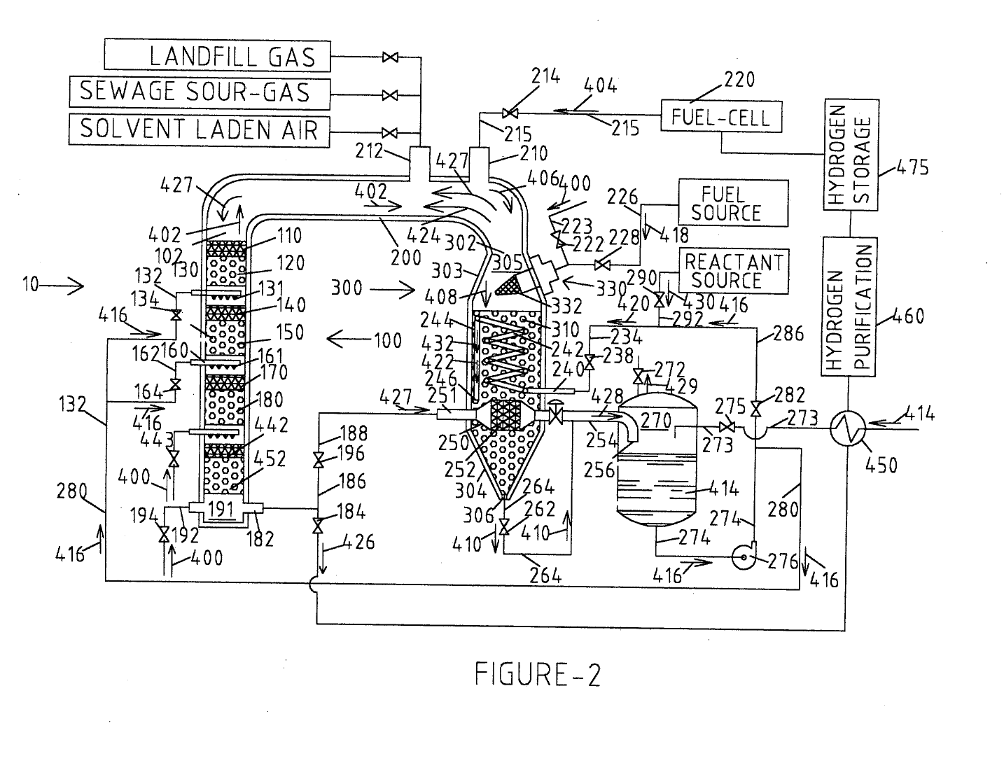

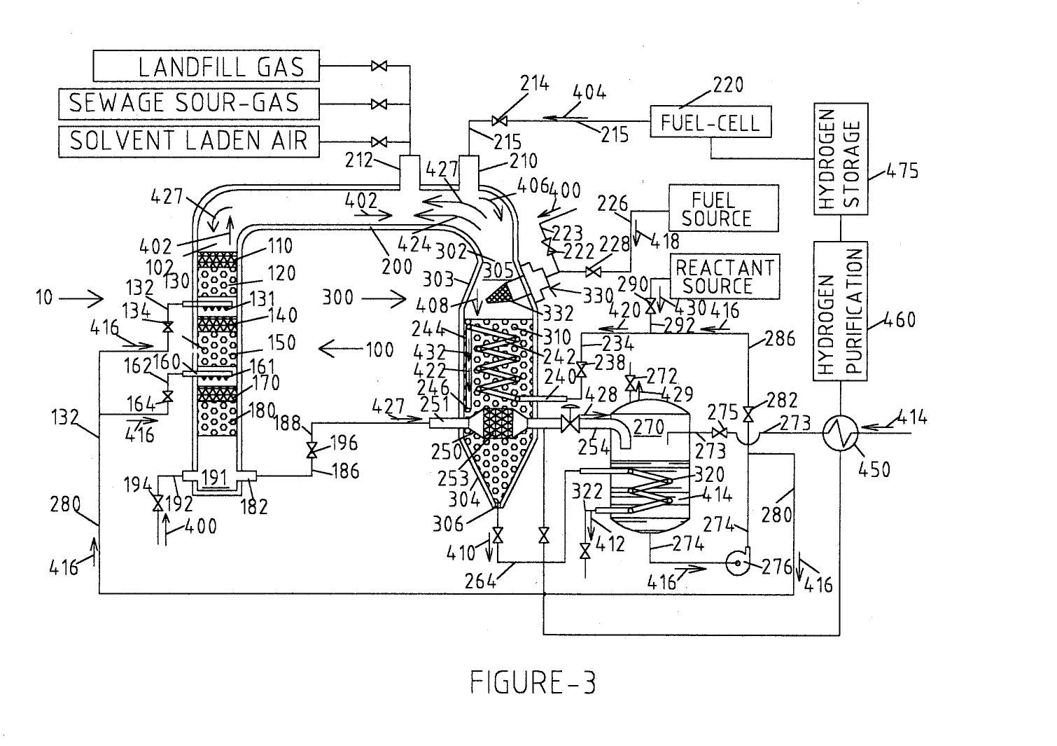

In an alternate arrangement shown in FIG. 2, the PROX reactor 440 is located as an additional stage or stages within reactor vessel 100. FIG. 2 shows reactor 100 containing a layer of PROX catalyst 442 followed by HSM bed 452 to recover the heat generated during the preferential oxidation of the carbon-monoxide in the PROX catalyst. As another alternate arrangement, PROX reactor 440 could be located within the heat storage vessel 300 (similar to the location of the catalytic combustion reactor 250). Yet alternately, as shown in FIG. 3, the combustion catalytic reactor 250 could be designed to function as a PROX reactor also. This dual function could be achieved by using a suitable catalyst 253 which could function as a combustion catalyst as well as a PROX catalyst. As shown in FIG. 3, suitable piping arrangement can be provided to divert the hot oxidized gas or the hydrogen containing product gas to either vessel 270 or to the hydrogen end-user.

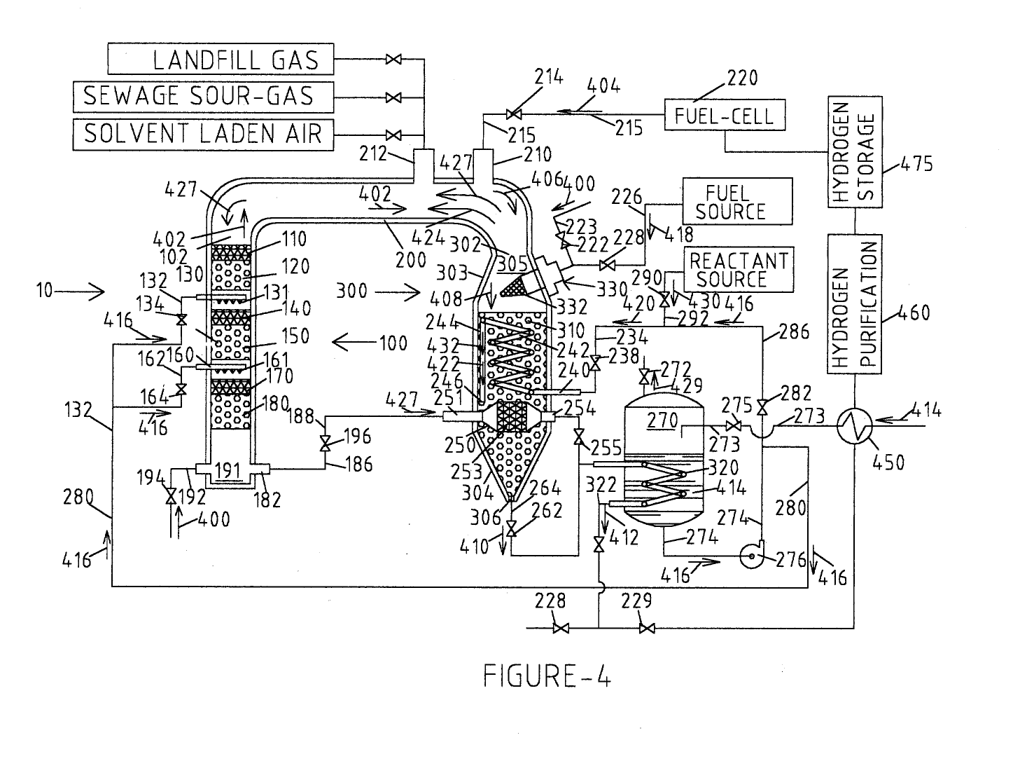

Further, the hydrogen-containing product gas 426 could be passed through suitable heat-exchange devices to further recover its sensible heat. Such heat-exchange devices could include gas-liquid heat-exchangers, such as that shown schematically and represented by the numeral 450 in FIG. 1, to transfer the sensible heat from the hot hydrogen-containing product gas 426 to cold water 414. Other heat exchanger devices could include a coil located within water storage tank 270 (similar to heat transfer coil 320) to transfer the heat from the hot hydrogen containing product gas 426 to the relatively colder water 414 in tank 270. Alternatively, as shown in FIG. 4, heat-transfer coil 320 could also be made to function as the heat-recovery heat-transfer coil for the hydrogen-containing product gas 426 by a suitable arrangement of valves 255, 262, 228, and 229.

The use of different hydrocarbon compounds as the fuel 418 during the heat storage mode of operation to fire burner 330 and as the reactant 430 during the reforming mode offers great economic advantage to the operation of fuel reformer 10 compared to fuel reformers of the prior art. For example, relatively less expensive liquid fuels such as diesel, kerosene, naphtha, fuel-oil, methanol, waste liquid hydrocarbons, etc. could be used to fire burner 330 during the heat storage mode and a gaseous hydrocarbon such as methane or propane or butane, etc. could be used as the reactant during the reforming mode of operation. Alternately, combustible solid wastes such as sawdust or wood-waste or agricultural waste such as rice husks/straw could also be burnt to provide the heat energy to heat the heat sink media 310 during the heat storage mode. The use of combustible solid wastes would conserve valuable, rapidly depleting fossil fuels while increasing the economic value of waste products. Thus, the operation of the disclosed fuel reformer would be more economical than current state of the art auto-thermal fuel reformers wherein a portion of the methane or propane is used to generate the heat required for sustaining the endothermic SMR reaction. Furthermore, it is not even necessary to provide fuel 418 and burner 330 to heat up the heat sink media 310 in heat storage vessel 300. For example, hot exhaust gas from process equipment such as furnaces or thermal oxidizers or incinerators or high-temperature ovens or cupola furnaces or boilers could be used to heat heat-sink media 310 in heat-storage vessel 300. The heat stored in the heated heat-sink media 310 could then be used to heat the reforming mixture of steam and reactant to the temperature required for the SMR reaction as described above.

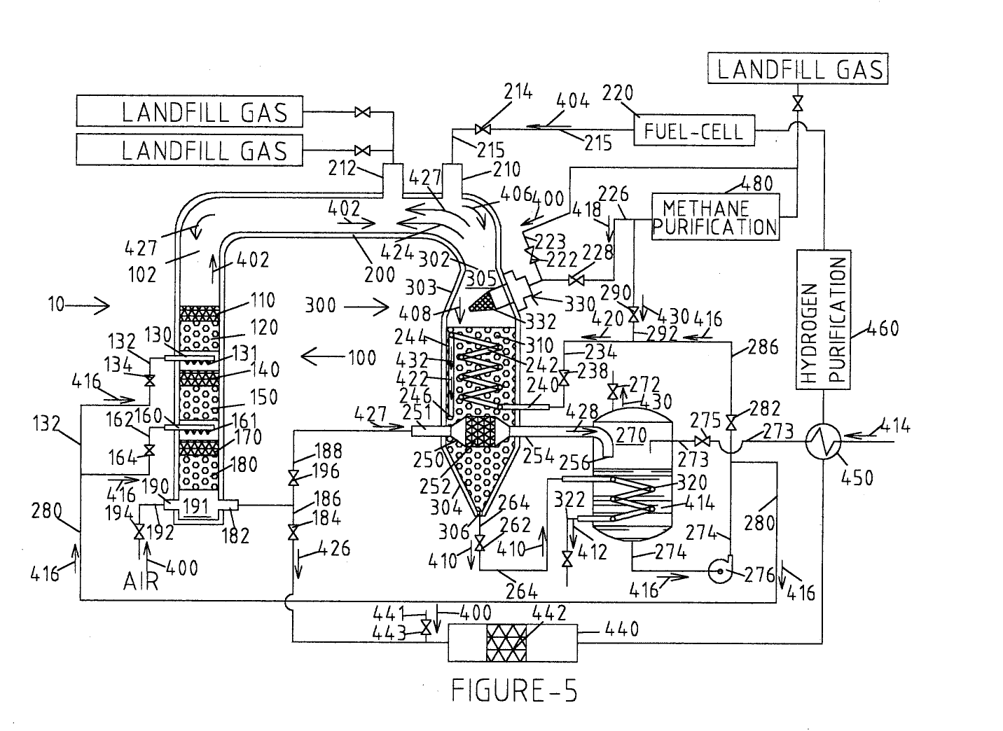

As shown in FIG. 5, a gas purification system 480 can be used to increase the BTU content of the low-BTU gas for use as fuel 418 in burner 330. The gas purification system 480 could also be used to purify the low-BTU gas so that it could also be used as reactant 430 in reformer 10. The gas purification system is commercially available from American Purification Systems Inc., and other US suppliers. Thus a smaller purification system can be used because a major proportion of the low-BTU gas could be directly combusted in combustion chamber 305.

As fuel reformer 10 is operated in the reforming mode for some time, the heat stored in heat sink media 310 within heat storage vessel 300 is gradually reduced. Thus less heat energy is available to heat the reactant-steam mixture in the heat storage vessel 300. Therefore, the temperature of the reactant-steam mixture 424, which leaves heat storage vessel 300, is also gradually reduced. When the temperature of the reactant-steam mixture 424 drops below a predetermined level, in the range of 1,000 to 1,200 degrees Fahrenheit which is required for the SMR reaction to be sustained in SMR catalyst 110, the reforming mode of operation of fuel-reformer 10 is ended and the heating mode of operation of fuel-reformer 10 is again started. Thus, the flow of reactant 430 and water 416 into heat-storage vessel 300 is stopped and all the relevant valves are opened or closed as required for the heating mode of operation of reformer 10. Burner 330 is then re-lit to provide heat for storage in heat sink media 310.

As shown in FIG. 1, an optional hydrogen purification system 460 such as a Pressure Swing Adsorption system available from Questor Inc., Canada or other manufacturer could be used to further purify the hydrogen gas to a very high concentration of hydrogen as required by the hydrogen-consuming industrial process or by the fuel-cell 220. The hydrogen containing product gas can also be stored without further purification by the PROX reactor 440 or the hydrogen purification system 460 or in its purer form after purification in hydrogen-storage means 475 for use as required by the hydrogen-consuming industrial process or by the fuel-cell 220. Thus the hydrogen-consuming industrial process or fuel-cell 220 could consume hydrogen continuously while hydrogen is produced intermittently by reformer 10.

By alternately operating fuel-reformer 10 in the heating and reforming modes as described, hydrogen-containing product gas can be generated in an economical and energy-efficient manner. This hydrogen-containing product gas can be used in processes, which require hydrogen-containing product gas or can be purified to produce relatively pure hydrogen-gas. Alternately, this hydrogen-containing product gas can be used directly in Proton Electrolyte Membrane (PEM) fuel-cells to generate electricity in an economical, pollution-free and energy-efficient manner.

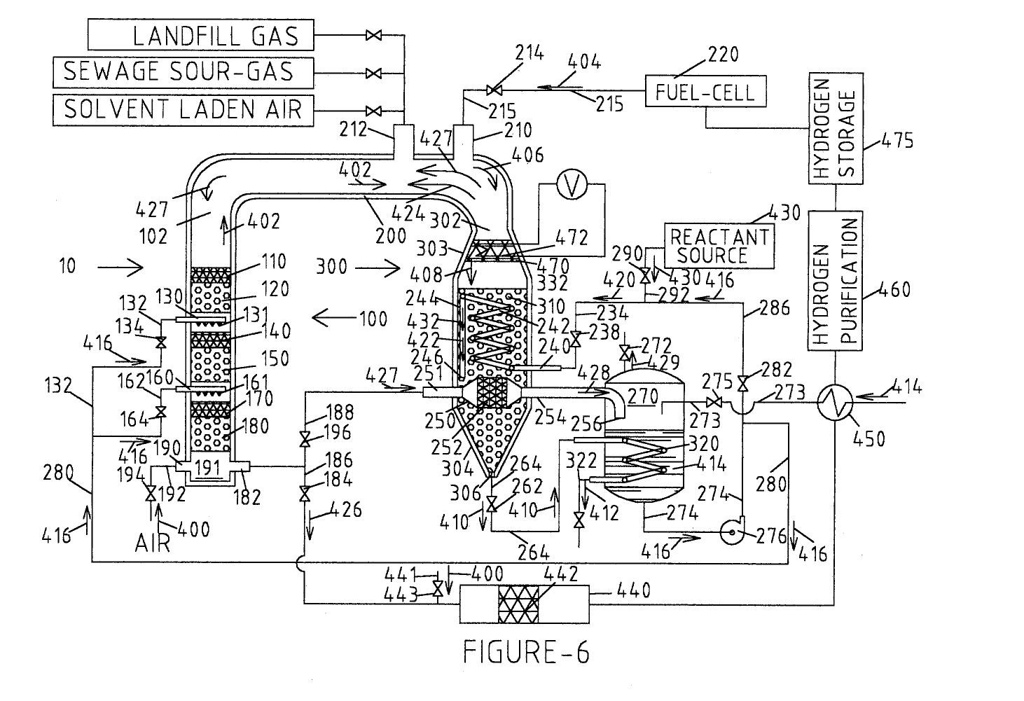

As shown in FIG. 6, a combustion catalyst 470 may also be used instead of combustion burner 330 to generate the heat to be stored in heat-sink media 310 in heat storage bed 300 during the heating mode of operation. For initial start-up, combustion catalyst 470 could be heated by an electric heating element 472 to bring combustion catalyst 470 up to an operating temperature that is suitable for the oxidation of the combustibles in low BTU gas mixture 406. Once HSM 310 has been heated during the reforming stage of the operation, the energy stored in the various heat-sink beds in reactor vessel 100 may be sufficient to sustain the operation of the catalyst during subsequent heating modes without additional input of electrical energy.

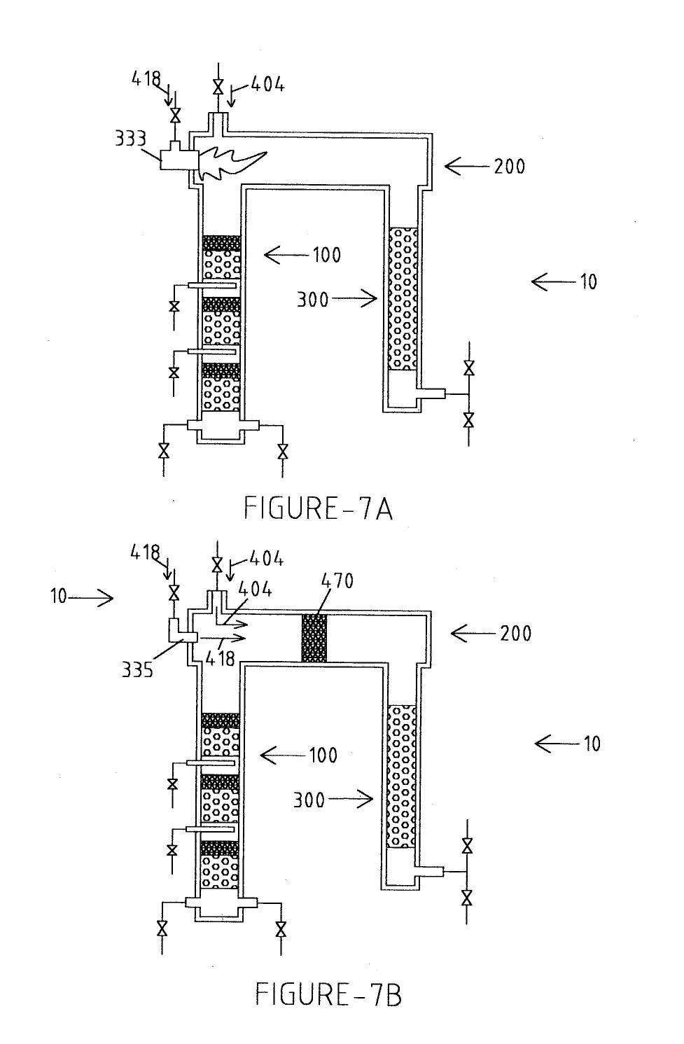

Other physical configurations can also be used for reformer 10. Some examples of other configurations that could be used for reformer 10 are shown in FIGS. 7A, and 7B. In FIG. 7A, a raw-gas burner 333 is shown located in the interconnecting duct 200. This arrangement provides longer contact time of the products of combustion of burner 333 with AOG 404 and/or other low-BTU gases. Thus more complete oxidation of the combustibles in AOG 404 and other/or low BTU gases takes place evolving more heat for storage in heat sink media 310.

Fuel-reformer 10 of FIG. 7B has the same general arrangement as fuel-reformer 10 of FIG. 7A except that combustion catalyst 470 is located in interconnecting duct 200. Fuel 418 is introduced into interconnecting duct 200 through injection nozzle 335. This arrangement provides better contact between AOG 404 and/or other low-BTU gases and combustion catalyst 470. Thus more complete oxidation of the combustibles in AOG 404 and other/or low BTU gases takes place evolving more heat for storage in heat sink media 310.

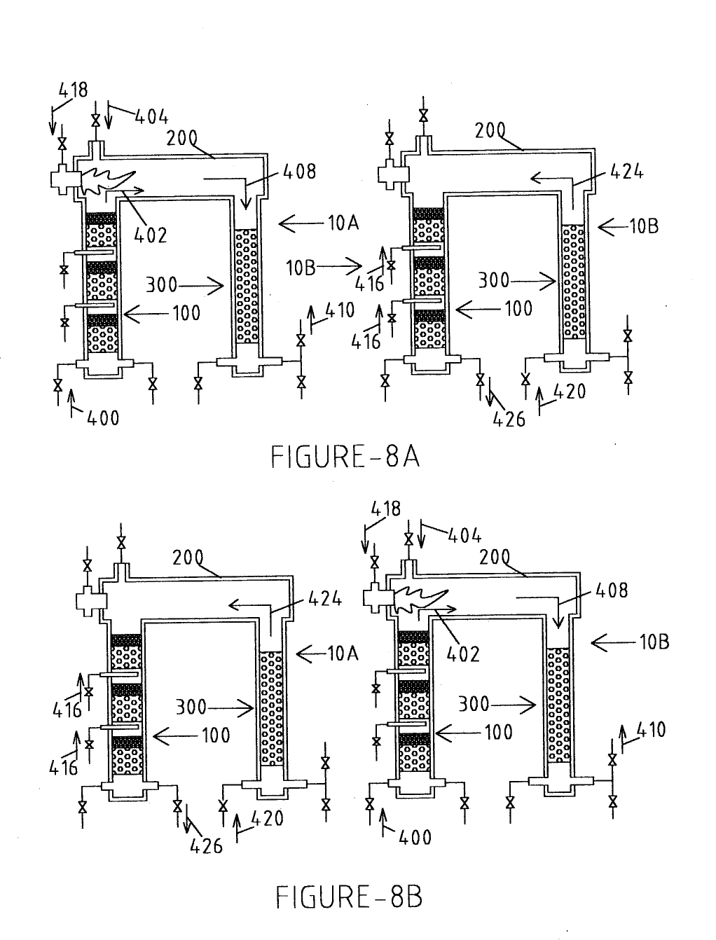

As shown in FIGS. 8A and 8B, two fuel reformers 10A and 10B can be used in parallel for continuous production of hydrogen-containing product gas 426. As shown in FIG. 8A, during a first time period, first fuel reformer 10A is operated in the heating mode as described previously with respect to fuel reformer 10 of FIG. 1. Simultaneously, second fuel reformer 10B is operated in the reforming mode as described previously with respect to fuel reformer 10 of FIG. 1. As shown in FIG. 8B, during the subsequent second period of time, the operating modes of the two fuel reformers are reversed so that first fuel reformer 10A is operated in the reforming mode while second fuel reformer 10B is operated in the heating mode. The cyclical operation of the two reformers is continued so that a hydrogen-containing product gas is generated continuously. Such a method of operation is suitable for situations where constant generation of hydrogen-containing gas may be required such as in fuel-cells

It should be noted that the above examples and embodiments of the present invention described above are only meant to be representative in nature. Yet other embodiments and variations of the present invention will be apparent to one of ordinary skill in the art and are construed as falling within the scope of the invention which should be evaluated in light of the following claims.

1. A method for generating a hydrogen-containing product gas, the method comprising:
heating a reactant stream which comprises at least one reactant selected from the set of reactants consisting of water, carbon-monoxide, oxygen, and a hydrocarbon fuel by passing the reactant stream through a first fluid-permeable bed of previously-heated first heat sink-media; and
contacting the heated reactant stream with a first catalyst which is suitable for producing a hydrogen containing product gas from the reactant stream.

2. The method of claim 1 wherein the reactant stream comprises water and hydrocarbon-fuel and the first catalyst comprises a Steam-Methane Reforming catalyst.

3. The method of claim 1, wherein the reactant stream comprises carbon-monoxide and water and the first catalyst comprises a Water Gas Shift catalyst.

4. The method of claim 1, wherein the reactant stream comprises oxygen, water, and hydrocarbon-fuel and the catalyst comprises an Advanced Catalyst.

5. The method of claim 1, further comprising the step of cooling the hydrogen containing product gas by passing the hydrogen containing product gas through a second fluid-permeable bed of previously cooled heat sink media.

6. The method of claim 2, further comprising the steps of
cooling the hydrogen containing product gas by passing the hydrogen containing product gas through a second fluid-permeable bed of previously cooled heat sink media to cool the hydrogen containing product gas to a temperature suitable for a Water-Gas Shift reaction; and passing the cooled hydrogen containing product gas through a Water Gas Shift catalyst.

7. A method for operating a fuel reformer, the method comprising:
operating the fuel reformer in a heating mode of operation followed by a reforming mode of operation, wherein the heating mode of operation comprises the steps of:
a) oxidizing a combustible to produce a hot flue gas;
b) passing the hot flue gas through a relatively cooler bed of fluid-permeable heat sink media to heat the bed; and
c) stopping the flow of the hot flue gas through the bed; and
wherein the reforming mode of operation comprises the steps of:
d) heating a reactant stream which comprises at least one reactant selected from the set of reactants consisting of water, carbon-monoxide, oxygen, and a hydrocarbon fuel by passing the reactant stream through the heated bed of fluid-permeable heat sink media;
e) further contacting the heated reactant stream with a first catalyst which is suitable for producing a hydrogen containing product gas from the reactant stream; and
f) stopping the flow of the reactant stream through the bed and the first catalyst.

8. The method of claim 7, wherein the reactant stream comprises water and hydrocarbon-fuel and the first catalyst comprises a Steam-Methane Reforming catalyst.

9. The method of claim 7, wherein the reactant stream comprises carbon-monoxide and water and the first catalyst comprises a Water Gas Shift catalyst.

10. The method of claim 7, wherein the reactant stream comprises oxygen, water, and hydrocarbon-fuel and the first catalyst comprises an Advanced Catalyst.

11. The method of claim 7, wherein the steps of operating the fuel-reformer in the heating and reforming modes of operation are repeated.

12. An apparatus for the generation of a hydrogen containing product gas from a reactant stream which comprises at least one reactant selected from the set of reactants comprising water, carbon-monoxide, oxygen, and a hydrocarbon fuel, the apparatus comprising:
a housing having an inlet for the flow of the reactant stream into the housing and an outlet for the flow of the hydrogen containing product gas out of the housing;
a first heat sink media contactingly located within the housing in the path of flow of the reactant stream, the first heat sink media being at a higher temperature than the reactant stream so that heat is transferred from the first heat sink media to the reactant stream to heat the reactant stream to a temperature greater than its inlet temperature; and
a first catalyst contactingly located within the housing in the path of flow of the heated reactant stream, the first catalyst being suitable for producing a hydrogen containing product gas from the heated reactant stream.

13. The apparatus of claim 12 wherein the reactant stream comprises water and hydrocarbon-fuel and the first catalyst comprises a Steam-Methane Reforming catalyst.

14. The apparatus of claim 12 wherein the reactant stream comprises carbon-monoxide and water and the first catalyst comprises a Water Gas Shift catalyst.

15. The apparatus of claim 12 wherein the reactant stream comprises oxygen, water, and hydrocarbon-fuel and the first catalyst comprises an Advanced Catalyst.

16. The apparatus of claim 12 further comprising a combustion chamber in fluid communication with the first heat sink media.

17. The apparatus of claim 12 further comprising
a second heat sink media contactingly located within the housing in the path of flow of the hydrogen containing product gas, the second heat sink media being at a lower temperature than the hydrogen containing product gas so that heat is transferred from the hydrogen containing product gas to the second heat sink media to cool the hydrogen containing product gas to a temperature less than its inlet temperature into the second heat sink media.

18. The apparatus of claim 17 wherein the reactant comprises water and hydrocarbon-fuel and the first catalyst comprises a Steam-Methane Reforming catalyst.

19. The apparatus of claim 18 further comprising a Water Gas Shift catalyst, the Water Gas Shift catalyst being contactingly located in the housing in the path of flow of the cooled hydrogen-containing product gas downstream of the second heat sink media to produce a relatively higher concentration hydrogen containing product gas.

20. The apparatus of claim 19 further comprising a third heat sink media contactingly located in the housing in the path of flow of the cooled relatively higher concentration hydrogen containing product gas downstream of the Water Gas Shift catalyst to produce a relatively cooler relatively higher concentration hydrogen containing product gas.
